(19) United States
(12) Patent Application Publication
(10) Pub. No.: US 2017/0327417 A1
(43) Pub. Date: Nov. 16, 2017

(54) GLASS MEMBER AND GLASS

(71) Applicant: ASAHI GLASS COMPANY, LIMITED, Chiyoda-ku (JP)

(72) Inventors: Naoaki MIYAMOTO, Tokyo (JP); Masabumi ITO, Tokyo (JP); Kazuya ISHIKAWA, Tokyo (JP)

(73) Assignee: ASAHI GLASS COMPANY, LIMITED, Chiyoda-ku (JP)

(21) Appl. No.: 15/665,780

(22) Filed: Aug. 1, 2017

Related U.S. Application Data
(63) Continuation of application No. PCT/JP2016/053687, filed on Feb. 8, 2016.

(30) Foreign Application Priority Data
Feb. 12, 2015 (JP) 2015-025339

(51) Int. Cl. C03C 17/32; C03C 17/36; F21V 8/00; F21S 2/00

(52) U.S. Cl. CPC C03C 17/32; C03C 17/3657; F21S 2/00; G02B 6/0051; G02B 6/0031

(57) ABSTRACT

The present invention relates to a glass member including a glass and a reflection sheet, in which the glass includes: a first surface; a second surface opposite to the first surface; at least one first end surface that is provided between the first surface and the second surface; and at least one second end surface that is provided between the first surface and the second surface and is different from the first end surface, the glass has an effective optical path length of 5 cm to 200 cm, the glass has an average internal transmittance of at least 80% in a visible light region over the effective optical path length, the second end surface has a surface roughness Ra of not higher than 0.8 μm, and the reflection sheet is disposed on the second end surface, and relates to a glass for use in the glass member.

### TECHNICAL FIELD

The present invention relates to a glass member and a glass.

### BACKGROUND ART

In recent years, a liquid crystal display device has been provided in a liquid crystal television, a tablet terminal, a portable information terminal typified by a smartphone, etc. The liquid crystal display device has a planar light emitting unit serving as a backlight, and a liquid crystal panel disposed on the light outgoing surface side of the planar light emitting unit.

Planar light emitting units are classified into a direct type and an edge light type. Edge light type light emitting units are often used because they can miniaturize light sources. Each edge light type planar light emitting unit includes a light source, a light guide plate, a reflection sheet, a diffusing sheet, etc.

Light from the light source enters the light guide plate from a light incoming end surface formed in a side surface of the light guide plate. In the light guide plate, a plurality of reflection dots are formed in a light reflection surface, which is an opposite surface to a light outgoing surface facing a liquid crystal panel. The reflection sheet is disposed to face the light reflection surface, and the diffusing sheet is disposed to face the light outgoing surface.

The light entering the light guide plate from the light source travels while being reflected by the reflection dots and the reflection sheet. Then, the light is emitted from the light outgoing surface. The light emitted from the light outgoing surface is diffused by the diffusing sheet. After that, the light is incident on the liquid crystal panel.

Glass having high transmittance and excellent heat resistance can be used as a material of the light guide plate (see Patent Documents 1 and 2).

### BACKGROUND ART DOCUMENT

### Patent Document

Patent Document 1: JP-A-2013-093195

Patent Document 2: JP-A-2013-030279

### SUMMARY OF THE INVENTION

### Problems that the Invention is to Solve

The aforementioned reflection sheet is also disposed in any other side surface (non-light incoming end surface) of the glass used as the light guide plate than the light incoming end surface. As a result, after the light from the light source enters the glass from the light incoming end surface, the light is suppressed from outgoing from any non-light incoming end surface. Thus, the light can be emitted efficiently from the light outgoing surface.

An exemplary object of an aspect of the present invention is to provide a glass member in which adhesion of a reflection sheet to a non-light incoming surface can be improved, and a glass for use in the glass member.

### Means for Solving the Problems

In order to achieve the above-described object, the present invention provides a glass member including a glass and a reflection sheet,

in which the glass includes:

a first surface;

a second surface opposite to the first surface;

at least one first end surface that is provided between the first surface and the second surface; and

at least one second end surface that is provided between the first surface and the second surface and is different from the first end surface,

the glass has an effective optical path length of 5 cm to 200 cm,

the glass has an average internal transmittance of at least 80% in a visible light region over the effective optical path length,

the second end surface has a surface roughness Ra of not higher than 0.8 μm, and

the reflection sheet is disposed on the second end surface.

Additionally, the present invention also provides a glass member including a glass,

in which the glass includes:

a first surface;

a second surface opposite to the first surface;

at least one first end surface that is provided between the first surface and the second surface; and

at least one second end surface that is provided between the first surface and the second surface and is different from the first end surface,

the glass has an effective optical path length of 5 cm to 200 cm,

the glass has an average internal transmittance of at least 80% in a visible light region over the effective optical path length, and

the second end surface has a surface roughness Ra of not higher than 0.8 μm.

### Advantage of the Invention

According to an aspect of the present invention, it is possible to provide a glass member in which adhesion of a reflection sheet to a non-light incoming end surface is improved, so that luminance can be prevented from lowering when the glass member is used as a light guide plate.

### BRIEF DESCRIPTION OF THE DRAWINGS

FIG. 1 is a schematic configuration diagram showing a liquid crystal display device in which a glass member according to an embodiment of the present invention is used as a light guide plate.

FIG. 2 is a view showing a light reflection surface of the light guide plate.

FIG. 3 is a perspective view of the light guide plate.

FIG. 4 is a view for explaining chamfering to be formed on the light guide plate.

FIG. 5 is a flow chart of a method for manufacturing the glass member according to the embodiment.

FIG. 6 is a view for explaining a cutting configuration in the method for manufacturing the glass member according to the embodiment.

FIG. 7 is a view for explaining a mirror-finishing step.

FIG. 8A and FIG. 8B are graphs for explaining a relation between surface roughness Ra and a transmittance difference among samples in Examples 1 to 6.

FIG. 9 is a graph for explaining a relation between surface roughness Ra and adhesion P among samples in Examples 7 to 14.

FIG. 10 is a graph for explaining a relation between surface roughness Ra and adhesion P among samples in Examples 15 to 22.

### MODE FOR CARRYING OUT THE INVENTION

Next, a non-limiting exemplary embodiment of the present invention will be described with reference to the accompanying drawings.

Incidentally, in the description of the accompany drawings, members or parts in one of the drawings the same as or corresponding to those in another are referenced correspondingly, and their redundant description will be omitted. In addition, the drawings are not intended to suggest any relative ratio among the members or parts unless the relative ratio is specified especially. Therefore, specific dimensions may be determined by those in the art with reference to the following non-limiting embodiment.

In addition, the embodiment that will be described below does not limit the present invention but is illustrative. All the features that will be described in the embodiment or the combinations of the features are not always essential to the present invention.

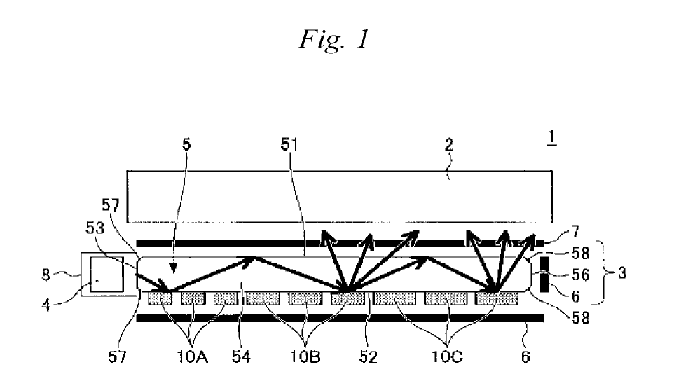

FIG. 1 shows a liquid crystal display device 1 using a glass member according to an embodiment of the present invention. The liquid crystal display device 1 is to be mounted on an electronic apparatus that has been miniaturized and thinned, such as a portable information terminal.

The liquid crystal display device 1 includes a liquid crystal panel 2 and a planar light emitting unit 3.

In the liquid crystal panel 2, an alignment layer, a transparent electrode, a glass substrate and a polarizing filter are layered with a liquid crystal layer disposed at the center. In addition, a color filter is disposed on one side of the liquid crystal layer. When a drive voltage is applied to the transparent electrode, molecules of the liquid crystal layer rotate around an alignment axis so that predetermined display can be performed.

As the planar light emitting unit 3, an edge light type is used in order to be miniaturized and thinned. The planar light emitting unit 3 includes a light source 4, a light guide plate 5, a reflection sheet 6, a diffusing sheet 7, and reflection dots 10A to 10C

Light entering the light guide plate 5 from the light source 4 travels while being reflected by the reflection dots 10A to 10C and the reflection sheet 6. The light is emitted from a light outgoing surface 51 of the light guide plate 5 facing the liquid crystal panel 2. The light emitted from the light outgoing surface 51 is diffused by the diffusing sheet 7. Then the light is incident on the liquid crystal panel 2.

The light source 4 is not limited especially. A hot cathode tube, a cold cathode tube, or an LED (Light Emitting Diode) may be used as the light source 4. The light source 4 is disposed to face a light incoming end surface 53 of the light guide plate 5.

In addition, a reflector 8 is provided on the back side of the light source 4 in order to enhance the incidence efficiency with which the light radiated radially from the light source 4 can enter the light guide plate 5.

The reflection sheet 6 has a configuration in which a surface of a sheet of resin such as acrylic resin has been coated with a light reflection member. The reflection sheet 6 is disposed on a light reflection surface 52 and non-light incoming end surfaces 54 to 56 of the light guide plate 5. The light reflection surface 52 is a surface of the light guide plate 5 facing the light outgoing surface 51. The non-light incoming end surfaces 54 to 56 are end surfaces of the light guide plate 5 excluding the light incoming end surface 53.

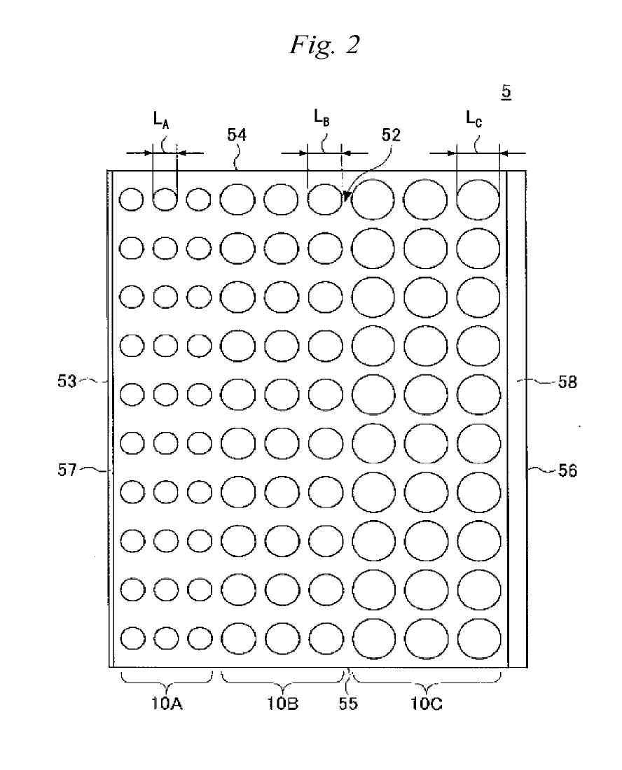

The glass member includes the light guide plate 5 and the reflection sheet 6. The reflection sheet 6 is disposed on at least the non-light incoming end surface 56 opposite to the light incoming end surface 53. Thus, the light entering the light guide plate 5 from the light incoming end surface 53 travels in a light traveling direction (rightward in FIG. 1 and FIG. 2) while being reflected inside the light guide plate 5. The light arriving at the non-light incoming end surface 56 can be reflected by the reflection sheet 6 so as to enter the light guide plate 5 again. In addition, it is preferable that the reflection sheet 6 is also disposed on the non-light incoming end surfaces 54, 55. In this manner, when the light scattered inside the light guide plate 5 arrives at the non-light incoming end surface 54 or 55, the light can be reflected by the reflection sheet 6 so as to enter the light guide plate 5 again.

A material of the resin sheet forming the reflection sheet 6 is not limited to acrylic resin. For example, polyester resin such as PET, urethane resin, a material obtained by a combination of those resins, etc. may be used.

As for the light reflection member forming the reflection sheet 6, for example, a metal deposited film or the like may be used.

An adhesive agent is applied to the reflection sheet 6 disposed on the non-light incoming end surfaces 54 to 56. As the adhesive agent applied to the reflection sheet 6, for example, acrylic resin, silicone resin, urethane resin, synthetic rubber, etc. may be used. The reflection sheet 6 is disposed on the non-light incoming end surfaces 54 to 56 through the adhesive agent.

The thickness of the reflection sheet 6 is not limited especially. For example, one having a thickness of 0.01 to 0.50 mm may be used as the reflection sheet 6.

A milk-white acrylic resin film or the like may be used as the diffusing sheet 7. The diffusing sheet 7 diffuses light emitted from the light outgoing surface 51 of the light guide plate 5 so that uniform light with no irregular luminance can be radiated to the back side of the liquid crystal panel 2. Incidentally, the reflection sheet 6 and the diffusing sheet 7 are fixed to predetermined positions of the light guide plate 5, for example, by adhesion.

Next, the light guide plate 5 will be described.

The light guide plate 5 is made of glass having high transparency. In this embodiment, multicomponent oxide glass is used as a material of the glass used as the light guide plate 5.

Specifically, glass having an effective optical path length of 5 cm to 200 cm and an average internal transmittance of at least 80% in a visible light region (wavelength of 380 nm to 800 nm) over the effective optical path length is used for the light guide plate 5. The average internal transmittance of the glass in the visible light region is preferably not lower than 82%, more preferably not lower than 85%, and further more preferably not lower than 90% over the effective optical path length. Incidentally, the effective optical path length of the glass designates a distance between a light incoming end surface from which light is incident on the glass and a non-light incoming end surface opposite to the light incoming end surface when the glass is used as a light guide plate. The distance corresponds to a horizontal length of the light guide plate 5 shown in FIG. 1. On the other hand, an average internal transmittance Tₐᵥₑ of the glass in the visible light region can be calculated by an evaluation method, which will be described later.

In addition, in the glass used for the light guide plate 5, an Y value of tri-stimulus values in an XYZ color system according to JIS Z8701 (appendix) within the effective optical path length is preferably not lower than 90%. The Y value is obtained by Y=Σ(S(λ)×y(λ)). Here, S(λ) is a transmittance in each wavelength, and y(λ) is a weighting coefficient for each wavelength. Accordingly, Σ(S(λ)×y(λ)) is a total sum of products of the weighting coefficients for the respective wavelengths and the transmittances in the wavelengths. Incidentally, y(λ) corresponds to M cones (G cones/green) of retinal cells in an eye, which most sensitively responds to light of a wavelength of 535 nm. The Y value is more preferably not lower than 91%, further more preferably not lower than 92%, and especially preferably not lower than 93% within the effective optical path length.

### (Measurement of Average Internal Transmittance of Glass in Visible Light Region)

Description will be made about a method for evaluating an internal transmittance Tᵢₙ and an average internal transmittance Tₐᵥₑ of glass in the visible light region.

First, a glass plate to be measured is torn in a direction perpendicular to a first main surface of the glass plate to obtain a sample A measuring 50 mm in length by 50 mm in width from a substantially central part of the glass plate. Next, it is checked whether arithmetic average roughness Ra is not higher than 0.03 μm in first and second torn surfaces opposite to each other in the sample A. When the arithmetic average roughness Ra is higher than 0.03 μm, the first and second torn surfaces are polished with loose abrasives of colloidal silica or cerium oxide. Next, for the first torn surface in the sample A, a transmittance T_{A} within a wavelength range of 400 nm to 800 nm is measured at a length of 50 mm in a normal direction of the first torn surface. The transmittance T_{A} is measured by use of a spectrometric apparatus (for example, UH4150 manufactured by Hitachi High-Technologies Corporation) capable of measuring at the length of 50 mm. The measurement is performed through a slit or the like making a beam width of incident light narrower than the plate thickness.

Next, a refractive index of the sample A in each wavelength of a g-line (435.8 nm), an F-line (486.1 nm), an e-line (546.1 nm), a d-line (587.6 nm) and a C-line (656.3 nm) is measured at a room temperature by a precise refractometer using a V-block method. Coefficients B₁, B₂, B₃, C₁, C₂ and C₃ in a Sellmeier dispersion equation (the following Expression (1)) are determined by a least squares method so as to be fitted to the obtained refractive indexes in the aforementioned respective wavelengths to obtain a refractive index n_{A} of the sample A.

n_{A}=[1+{B₁λ²/λ²−C₁)}+{B₂λ²/λ²−C₂)}+{B₃λ²/λ²−C₃)}]^{0.5} (1)

Incidentally, λ is a wavelength in Expression (1).

A reflection factor R_{A} in each of the first and second torn surfaces of the sample A is obtained by the following theoretical equation (Expression (2)).

R_{A}=(1−n_{A})²/(1+n_{A})² (2)

Next, influence of reflection is eliminated from the transmittance T_{A} of the sample A at the length of 50 mm using the following Expression (3). Thus, an internal transmittance Tᵢₙ of the sample A at the length of 50 mm in the normal direction from the first torn surface is obtained.

Tᵢₙ=[−(1−R_{A})²+{(1−R_{A})⁴+4T_{A}²R_{A}²}^{0.5}]/(2T_{A}R_{A}²) (3)

The internal transmittances Tᵢₙ obtained for the respective wavelengths are averaged over the measurement wavelength region to calculate the average internal transmittance Tₐᵥₑ of the glass plate.

A total iron content A of the glass used for the light guide plate 5 is preferably not higher than 150 ppm in order to satisfy the aforementioned average internal transmittance and the Y value within the visible light region over the effective optical path length. The total iron content A of the glass used for the light guide plate 5 is more preferably not higher than 80 ppm, and further more preferably not higher than 50 ppm. On the other hand, the total iron content A of the glass used for the light guide plate 5 is preferably not lower than 5 ppm in order to improve dissolubility of the glass when multicomponent oxide glass is manufactured. The total iron content A of the glass used for the light guide plate 5 is more preferably not lower than 10 ppm, and further more preferably not lower than 20 ppm. Incidentally, the total iron content A of the glass used for the light guide plate 5 can be adjusted by the amount of iron to be added when the glass is manufactured.

In the present description, the total iron content A of the glass is expressed as an Fe₂O₃ content. However, all the iron present in the glass does not always have a shape of Fe³⁺ (trivalent iron). Typically, Fe³⁻ and Fe²⁺ (divalent iron) are present together in the glass. Fe³⁺ and Fe²⁺ show absorption in the visible light region. The absorption coefficient (11 cm⁻¹ Mol⁻¹) of Fe²⁺ is one digit larger than the absorption coefficient (0.96 cm⁻¹ Mol⁻¹) of Fe³⁺. Fe²⁺ depresses the internal transmittance in the visible light region. It is therefore preferable that the Fe²⁺ content is reduced to enhance the internal transmittance in the visible light region.

When the Fe²⁺ content of the glass used for the light guide plate 5 satisfies the conditions that will be described later, absorption of light in the wavelength of 600 nm to 780 nm can be suppressed. Thus, the glass can be used effectively even when the effective optical path length is changed depending on the dimensions of a display as in an edge light type.

It is preferable that the glass used for the light guide plate 5 satisfies a relation of 2.5(cm·ppm)≦L×B≦3000(cm·ppm) when the effective optical path length is denoted as L (cm) and the Fe²⁺ content is denoted as B (ppm, calculated as Fe₂O₃). When L×B<2.5(cm·ppm), the Fe²⁺ content B of the glass used for the light guide plate 5 for use in a planar light emitting unit measuring 25 cm to 200 cm in effective optical path length is 0.05 to 0.1 ppm. Such a glass cannot be mass-produced easily at a low cost. When L×B>3000(cm·ppm), the absorption of light in the wavelength of 600 nm to 780 nm is increased due to richness in Fe²⁺ content of the glass used for the light guide plate 5. Thus, due to deterioration in internal transmittance in the visible light region, there is a concern that the aforementioned average internal transmittance and the Y value over the effective optical path length cannot be satisfied. It is more preferable that the glass used for the light guide plate 5 satisfies a relation of 10(cm·ppm)≦L×B≦2400(cm·ppm). It is further more preferable that the glass used for the light guide plate 5 satisfies a relation of 25(cm·ppm)≦L×B=1850(cm·ppm).

The Fe²⁺ content B of the glass used for the light guide plate 5 is preferably not higher than 30 ppm in order to satisfy the aforementioned average internal transmittance and the Y value within the visible light region over the effective optical path length. The Fe²⁺ content B of the glass used for the light guide plate 5 is more preferably not higher than 20 ppm, and further more preferably not higher than 10 ppm. On the other hand, the Fe²⁺ content B of the glass used for the light guide plate 5 is preferably not lower than 0.02 ppm in order to improve dissolubility of the glass when multicomponent oxide glass is manufactured. The Fe²⁺ content B of the glass used for the light guide plate 5 is more preferably not lower than 0.05 ppm, and further more preferably not lower than 0.1 ppm.

Incidentally, the Fe²⁺ content of the glass used for the light guide plate 5 can be adjusted by the amount of oxidizing agents to be added when the glass is manufactured. Specific kinds of oxidizing agents to be added when the glass is manufactured and specific dosages of the oxidizing agents will be described later. The Fe₂O₃ content A is a total iron content (mass ppm) calculated as Fe₂O₃. The Fe₂O₃ content A is obtained by fluorescent X-ray measurement. The Fe²⁺ content B is measured according to ASTM C169-92. Incidentally, the measured Fe²⁺ content is expressed by calculation as Fe₂O₃.

It is preferable that the multicomponent oxide glass used for the light guide plate 5 has a low content of components having absorption in the visible light region in order to satisfy the aforementioned average internal transmittance and the Y value within the visible light region over the effective optical path length. Examples of the components having absorption in the visible light region may include MnO₂, TiO₂, NiO, CoO, V₂O₅, CuO and Cr₂O₃. In the glass used for the light guide plate 5, it is preferable that the total content of those components (at least one kind selected from the group consisting of MnO₂, TiO₂, NiO, CoO, V₂O₅, CuO and Cr₂O₃) is not higher than 0.1% (i.e., not higher than 1,000 ppm) in terms of mass % on the basis of oxides. The total content of the components is more preferably not higher than 0.08% (i.e., not higher than 800ppm), and further more preferably not higher than 0.05% (i.e., not higher than 500 ppm).

Specific examples of composition of the glass used for the light guide plate 5 will be described below. However, the composition of the glass used for the light guide plate 5 is not limited to those examples.

In a configuration example (configuration example A) of the glass used for the light guide plate 5, the composition of the glass excluding iron includes SiO₂ of 60 to 80%, Al₂O₃ of 0 to 7%, MgO of 0 to 10%, CaO of 4 to 20%, Na₂O of 7 to 20%, and K₂O of 0 to 10% in terms of mass % on the basis of oxides.

In another configuration example (configuration example B) of the glass used for the light guide plate 5, the composition of the glass excluding iron includes SiO₂ of 45 to 80%, Al₂O₃ of higher than 7% and not higher than 30%, B₂O₃ of 0 to 15%, MgO of 0 to 15%, CaO of 0 to 6%, Na₂O of 7 to 20%, K₂O of 0 to 10%, and ZrO₂ of 0 to 10% in terms of mass % on the basis of oxides.

In further another configuration example (configuration example C) of the glass used for the light guide plate 5, the composition of the glass excluding iron includes SiO₂ of 45 to 70%, Al₂O₃ of 10 to 30%, B₂O₃ of 0 to 15%, at least one kind selected from the group consisting of MgO, CaO, SrO and BaO of 5 to 30%, at least one kind selected from the group consisting of Li₂O, Na₂O and K₂O of not lower than 0% but lower than 7%, in terms of mass % on the basis of oxides.

However, the glass used for the light guide plate 5 is not limited to such compositions.

The light guide plate 5 includes the light outgoing surface 51 (first surface), the light reflection surface 52 (second surface), the light incoming end surface 53 (first end surface), the non-light incoming end surfaces 54 to 56 (second end surfaces), light incoming side chamfered surfaces 57 (first chamfered surfaces), and non-light incoming side chamfered surfaces 58 (second chamfered surfaces) as shown in FIG. 2 to FIG. 5 in addition to FIG. 1.

The light outgoing surface 51 is a surface facing the liquid crystal panel 2. In the embodiment, the light outgoing surface 51 is formed into a rectangular shape in planar view (in a state where the light outgoing surface 51 is observed from above). However, the shape of the light outgoing surface 51 is not limited to such a shape.

Dimensions of the light outgoing surface 51 are determined correspondingly to the liquid crystal panel 2. Therefore, the dimensions of the light outgoing surface 51 are not limited especially. In the embodiment, for example, the light outgoing surface 51 measures 1,200 mm by 700 mm.

The light reflection surface 52 is a surface opposite to the light outgoing surface 51. The light reflection surface 52 is arranged to be parallel with the light outgoing surface 51. In addition, the shape and dimensions of the light reflection surface 52 are formed to be the same as those of the light outgoing surface 51.

However, the light reflection surface 52 does not have to be made parallel to the light outgoing surface 51, but may be arranged with a step or a slope. In addition, the light reflection surface 52 may have different dimensions from the light outgoing surface 51.

The reflection dots 10A to 10C are formed on the light reflection surface 52 as shown in FIG. 2. The reflection dots 10A to 10C are formed by printing like dots in white ink. Luminance of light incident from the light incoming end surface 53 is strong, but is lowered by being reflected inside the light guide plate 5.

Therefore, in the embodiment, the sizes of the reflection dots 10A to 10C are changed in the traveling direction (rightward in FIG. 1 and FIG. 2) of the light from the light incoming end surface 53. Specifically, the reflection dots 10A located in an area close to the light incoming end surface 53 are set to have a small diameter (L_{A}), and as goes in the traveling direction of the light, the reflections dots 10B and 10C are set to have larger diameters (L_{B} and L_{C}) respectively (L_{A}<L_{B}<L_{C}).

When the size of each reflection dot 10A is changed in the traveling direction of the light inside the light guide plate 5 in this manner, the luminance of outgoing light emitted from the light outgoing surface 51 can be made so uniform that occurrence of irregular luminance can be suppressed. Incidentally, the size of each reflection dot 10A is not changed, but the number density of the reflection dots 10A may be changed in the traveling direction of the light inside the light guide plate 5. Also in this case, an equivalent effect can be obtained. Alternatively, grooves reflecting incident light may be formed in the light reflection surface 52 in place of the reflection dots 10A. Also in this case, an equivalent effect can be obtained.

In the embodiment, four end surfaces are formed between the light outgoing surface 51 and the light reflection surface 52. Of the four end surfaces, the light incoming end surface 53 as the first end surface is a surface on which light from the aforementioned light source 4 is incident. The non-light incoming surfaces 54 to 56 as the second end surfaces are surfaces on which the light from the light source 4 is not incident.

The light from the light source 4 is not incident on the non-light incoming end surfaces 54 to 56. Therefore, the non-light incoming end surfaces 54 to 56 do not have to be processed as precisely as the light incoming end surface 53. The surface roughness Ra of the non-light incoming end surfaces 54 to 56 is made not higher than 0.8 μm. The reason why the surface roughness Ra of the non-light incoming end surfaces 54 to 56 is made not higher than 0.8 μm will be described below. Incidentally, in the following description, the expression of the surface roughness Ra designates arithmetic average roughness (center line average roughness) according to JIS B 0601 to JIS B 0031.

As shown in FIG. 1, the reflection sheet 6 is adhered to the non-light incoming end surfaces 54 to 56. On this occasion, when the surface roughness Ra of the non-light incoming end surfaces 54 to 56 exceeds 0.8 μm, the reflection sheet 6 cannot properly be adhered to the non-light incoming end surfaces 54 to 56. On the other hand, when the surface roughness Ra of the non-light incoming end surfaces 54 to 56 is not higher than 0.8 μm, the reflection sheet can have good adhesion to the non-light incoming end surfaces 54 to 56. In this manner, the reflection sheet 6 can be prevented from peeling off, so that the reliability of the planar light emitting unit 3 can be enhanced. The surface roughness Ra of the non-light incoming end surfaces 54 to 56 is preferably not higher than 0.4 μm, more preferably not higher than 0.2 μm, further more preferably not higher than 0.1 μm, and especially preferably not higher than 0.04 μm.

In addition, in the embodiment, grinding or polishing is not performed on the non-light incoming end surfaces 54 to 56. Therefore, the surface roughness Ra of each of the non-light incoming end surfaces 54 to 56 is set to be higher than the surface roughness Ra of the light incoming end surface 53. The surface roughness Ra of the non-light incoming end surfaces 54 to 56 is preferably not lower than 0.01 μm, and more preferably not lower than 0.03 μm. As a result, processing of the non-light incoming end surfaces 54 to 56 becomes easier than processing of the light incoming end surface 53, or processing of the non-light incoming end surfaces 54 to 56 can be omitted. Thus, productivity is improved. However, grinding or polishing may be performed on the non-light incoming end surfaces 54 to 56. The surface roughness Ra of the non-light incoming end surfaces 54 to 56 may be equal to the surface roughness Ra of the light incoming end surface 53. That is, the surface roughness Ra of the non-light incoming end surfaces 54 to 56 is preferably not lower than the surface roughness Ra of the light incoming end surface 53, and the surface roughness Ra of the non-light incoming end surfaces 54 to 56 is more preferably higher than the surface roughness Ra of the light incoming end surface 53.

In addition, as shown in FIG. 4, it is preferable that an average value Lₐᵥₑ in the chamfered surface longitudinal direction (hereinafter simply referred to as a longitudinal direction) of a width L (mm) is 0.25 to 9.8 mm when L designates the width of the non-light incoming end surfaces 54 to 56 (that is, the size in the plate thickness direction in a part of each surface provided between the first surface and the second surface, excluding the non-light incoming side chamfered surfaces 58, which will be described later). Lₐᵥₑ is more preferably 0.50 to 9.8 mm. When Lₐᵥₑ is not larger than 9.8 mm, a width Y of each non-light incoming chamfered surface 58 can be sufficiently secured. When Lₐᵥₑ is not smaller than 0.25 mm, an error of L which will be described later can be reduced.

In fact, an error caused by unevenness in processing during cutting or chamfering occurs in the longitudinal direction in the width L of the non-light incoming end surfaces 54 to 56. When the average value of the width L of the non-light incoming end surfaces 54 to 56 in the longitudinal direction is denoted as Lₐᵥₑ (mm), it is preferable that the error of L in the longitudinal direction is within 50% of Lₐᵥₑ. That is, when the maximum value and the minimum value of L in the longitudinal direction are denoted as Lₘₐₓ (mm) and Lₘᵢₙ (mm), it is preferable to satisfy Lₘₐₓ≦1.5×Lₐᵥₑ and Lₘᵢₙ≧0.5×Lₐᵥₑ. The aforementioned error is more preferably within 40%, further more preferably within 30%, and especially preferably within 20%. In this manner, the error of the width L of the non-light incoming end surfaces 54 to 56 in the longitudinal direction can be reduced to reduce irregular luminance occurring when the light is reflected by the reflection sheet 6 inside the light guide plate 5.

Although the reflection sheet 6 is disposed on the non-light incoming end surfaces 54 to 56 as described above, voids are generated in an interface between each non-light incoming end surface 54-56 and the reflection sheet 6 due to adhesion failure. The ratio of the area occupied by the voids per unit area in the interface between each non-light incoming end surface and the reflection sheet (hereinafter also referred to as area void ratio) can be reduced by proper selection of the surface roughness Ra or the shape of the non-light incoming end surfaces 54 to 56, the adhesive agent contained in the reflection sheet 6, etc. The area void ratio in the interface between each non-light incoming end surface 54-56 and the reflection sheet 6 is preferably not higher than 40%, more preferably not higher than 30%, and further more preferably not higher than 20%. When the area void ratio is not higher than 40%, reduction in luminance caused by the voids when light is reflected by the reflection sheet 6 inside the light guide plate 5 can be suppressed.

The area void ratio can be calculated by the following method. First, peel adhesion P (N/10 mm) of the reflection sheet to a non-light incoming end surface whose area void ratio should be calculated is measured in the interface between the non-light incoming end surface and the reflection sheet. Incidentally, the peel adhesion P (N/10 mm) can be measured by peel adhesion testing according to JIS Z 0237. After that, peel adhesion P₀ (N/10 mm) of the reflection sheet to an end surface of glass having the same glass composition and the same shape as the non-light incoming end surface and having a surface roughness Ra not higher than 0.0050 μm is also measured in the same manner. Here, when the area void ratio of the end surface whose surface roughness Ra is not higher than 0.0050 μm is 0%, the area void ratio V (%) in the interface between the non-light incoming end surface and the reflection sheet can be calculated by the following Expression 1.

V=100×(1−P/P₀) (Expression 1)

It is preferable that the light incoming end surface 53 is mirror-finished when the glass as the light guide plate 5 is manufactured. Specifically, it is preferable that the arithmetic average roughness (center line average roughness) Ra of the light incoming end surface 53 is made not higher than 0.03 μm. As a result, the incidence efficiency of the light entering the light guide plate 5 from the light source 4 can be enhanced. The width W (see FIG. 4) of the light incoming end surface 53 is set at a width required from the liquid crystal display device 1 mounted with the planar light emitting unit 3. The surface roughness Ra of the light incoming end surface 53 is preferably not higher than 0.01 μm, and more preferably not higher than 0.005 μm.

In the embodiment, the light incoming side chamfered surfaces 57 are formed between the light outgoing surface 51 and the light incoming end surface 53 and between the light reflection surface 52 and the light incoming end surface 53 respectively.

Incidentally, an example in which the light incoming side chamfered surfaces 57 are formed both between the light outgoing surface 51 and the light incoming end surface 53 and between the light reflection surface 52 and the light incoming end surface 53 is shown in the embodiment. However, according to another configuration, a light incoming side chamfered surface 57 may be formed either between the light outgoing surface 51 and the light incoming end surface 53 or between the light reflection surface 52 and the light incoming end surface 53.

In the planar light emitting unit 3 required to be miniaturized and thinned as in the embodiment, it is preferable that the thickness of the light guide plate 5 is also reduced. It is therefore preferable that the thickness t of the light guide plate 5 according to the embodiment is not larger than 10 mm. However, in a configuration in which the light incoming side chamfered surfaces 57 are not provided in the light guide plate 5 but the light guide plate 5 has corner portions, the corner portions of the light guide plate 5 may touch another constituent member and be damaged, for example, during assembling of the light guide plate 5 in the planar light emitting unit 3. Thus, the strength of the light guide plate 5 may be reduced. It is therefore preferable that the thickness t of the light guide plate 5 according to the embodiment is not smaller than 0.5 mm. In addition, the light incoming side chamfered surfaces 57 are formed at the upper and lower edges of the light incoming end surface 53.

In order to enhance the incidence efficiency of light entering the light guide plate 5 from the light source 4, it is necessary to increase the area of the light incoming end surface 53. It is therefore desirable that the light incoming side chamfered surfaces 57 are smaller. To this end, chamfering as the light incoming side chamfered surfaces 57 is performed in the embodiment.

Here, as shown in FIG. 4, when the width of each light incoming side chamfered surface 57 (chamfered surface) is denoted as X (mm), an average value Xₐᵥₑ of the width X in the chamfered surface longitudinal direction (hereinafter simply referred to as longitudinal direction) is preferably 0.01 mm to 0.5 mm, more preferably 0.05 mm to 0.5 mm, and especially preferably 0.1 mm to 0.5 mm. When Xₐᵥₑ is not larger than 0.5 mm, the width W of the light incoming end surface 53 can be increased. When Xₐᵥₑ is not smaller than 0.1 mm, an error of X which will be described later can be reduced. When Xₐᵥₑ is not smaller than 0.01mm, breakage originating from the chamfered surface can be suppressed to enhance handleability.

In fact, an error caused by unevenness in processing during chamfering occurs in the longitudinal direction in the width X of the light incoming side chamfered surfaces 57. When the average value of the width X of light incoming side chamfered surfaces 57 in the longitudinal direction is denoted as Xₐᵥₑ (mm), it is preferable that the error of X in the longitudinal direction is within 50% of Xₐᵥₑ. That is, it is preferable to satisfy 0.5Xₐᵥₑ≦X≦1.5Xₐᵥₑ. The aforementioned error is more preferably within 40%, further more preferably within 30%, and especially preferably within 20%. In this manner, the error of the width X of the light incoming side chamfered surfaces 57 and the error of the width W of the light incoming end surface 53 in the longitudinal direction can be reduced to reduce irregular luminance occurring in the light guide plate 5.

In addition, it is preferable that the surface roughness Ra of the light incoming side chamfered surfaces 57 is made not higher than 0.4 μm. When the surface roughness Ra of the light incoming side chamfered surfaces 57 is made not higher than 0.4 μm, the amount of generated cullet can be suppressed to reduce occurrence of irregular luminance in the light guide plate 5. As the width X of the light incoming side chamfered surfaces 57 increases, the amount of generated cullet also increases. Therefore, the surface roughness Ra of the light incoming side chamfered surfaces 57 is more preferably not higher than 0.3 μm, further more preferably not higher than 0.1 μm, and especially preferably not higher than 0.03 μm.

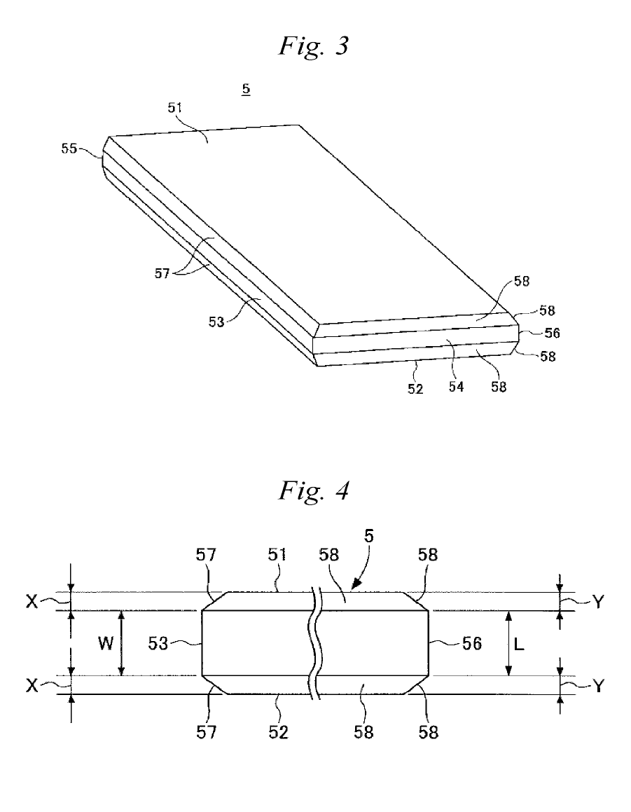

In addition, the non-light incoming side chamfered surfaces 58 are formed between the light outgoing surface 51 and the non-light incoming end surface 54, between the light reflection surface 52 and the non-light incoming end surface 54, between the light outgoing surface 51 and the non-light incoming end surface 55, between the light reflection surface 52 and the non-light incoming end surface 55, between the light outgoing surface 51 and the non-light incoming end surface 56, and between the light reflection surface 52 and the non-light incoming end surface 56 respectively as shown in FIG. 3. However, all the aforementioned non-light incoming side chamfered surfaces 58 do not have to be formed. According to another configuration, the non-light incoming side chamfered surfaces 58 may be formed selectively.

Here, as shown in FIG. 4, when the width of each non-light incoming side chamfered surface 58 is denoted as Y (mm), it is preferable that an average value Yₐᵥₑ of the width Y in the longitudinal direction is 0.1 mm to 0.6 mm. When Yₐᵥₑ is not larger than 0.6 mm, the width L of the non-light incoming end surfaces 54 to 56 can be increased. When Yₐᵥₑ is not smaller than 0.1 mm, an error of Y which will be described later can be reduced.

An error caused by unevenness in processing during chamfering occurs in the longitudinal direction in the width Y of the light incoming side chamfered surfaces 58. When the average value of the width Y of the non-light incoming side chamfered surfaces 58 in the longitudinal direction is denoted as Yₐᵥₑ (mm), it is preferable that the error of Y in the longitudinal direction is within 50% of Yₐᵥₑ. That is, it is preferable to satisfy 0.5Yₐᵥₑ≦Y≦1.5Yₐᵥₑ. The aforementioned error is more preferably within 40%, further more preferably within 30%, and especially preferably within 20%. In this manner, the error of the width L in the longitudinal direction of the non-light incoming end surfaces 54 to 56 by which incident light is reflected can be reduced to reduce irregular luminance occurring in the light guide plate 5.

In addition, the surface roughness Ra of the non-light incoming side chamfered surfaces 58 is made higher than the surface roughness Ra of the light incoming side chamfered surfaces 57 in view of improvement in productivity. The surface roughness Ra of the non-light incoming side chamfered surfaces 58 is made preferably not lower than 0.03 μm, more preferably not lower than 0.1 μm, further more preferably not lower than 0.3 μm, and especially preferably not lower than 0.4 μm. On the other hand, it is preferable that the surface roughness Ra of the non-light incoming side chamfered surfaces 58 is made not higher than 1.0 μm. Further, when the surface roughness Ra of the non-light incoming side chamfered surfaces 58 is not lower than 0.4 μm and not higher than 1.0 μm, the adhesion between the reflection sheet 6 and each non-light incoming side chamfered surface 58 can be improved when the reflection sheet 6 is adhered thereon. In addition, it is possible to reduce irregular luminance occurring in the light guide plate 5.

Next, a method for manufacturing the glass serving as the light guide plate 5 will be described.

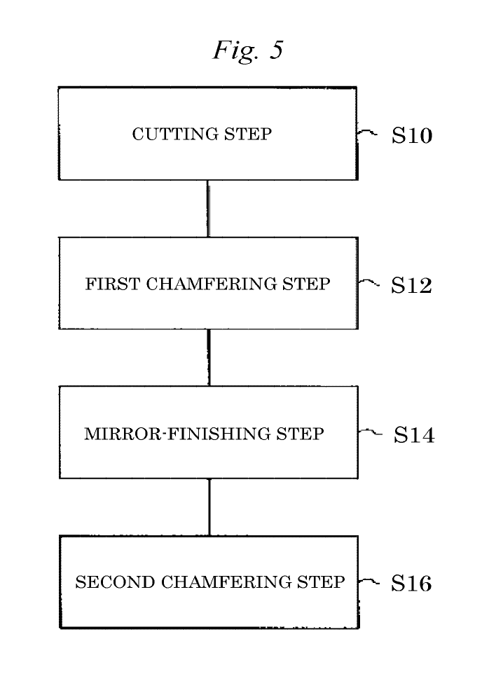

FIGS. 5 to 7 are a chart and graphs for explaining the method for manufacturing the light guide plate 5. FIG. 5 is a flow chart showing the method for manufacturing the light guide plate 5.

To manufacture the light guide plate 5, first, a glass raw material 12 is prepared. The glass raw material 12 has an effective optical path length of 5 cm to 200 cm as described above, and preferably has a thickness of 0.5 mm to 10 mm. The average internal transmittance of the glass raw material 12 in the visible light region over the effective optical path length is not lower than 80%, and a Y value of tri-stimulus values in an XYZ color system according to JIS Z8701 (appendix) is preferably not lower than 90%. The glass raw material 12 is set to have a larger shape than the established shape of the light guide plate 5.

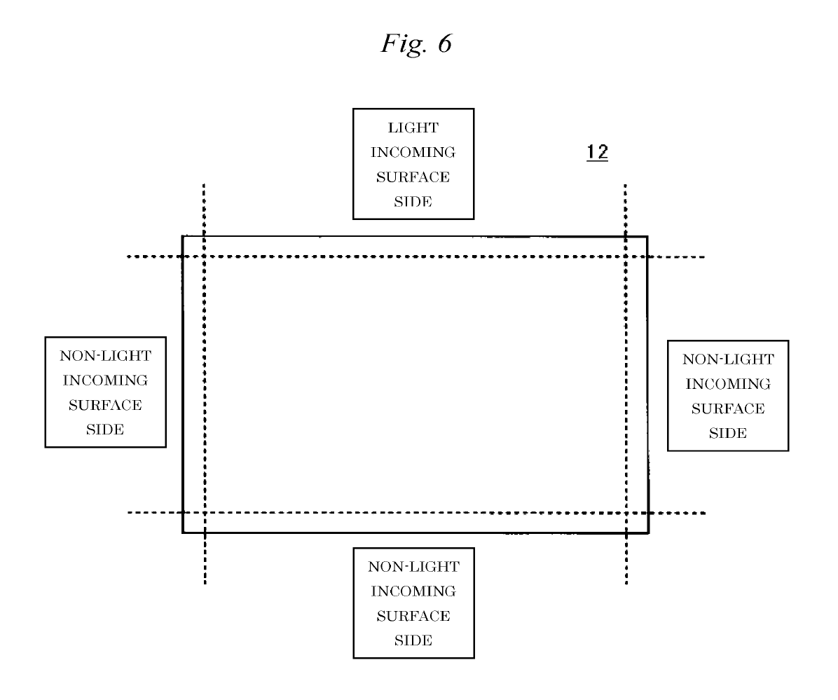

First, a cutting step shown by Step 10 in FIG. 5 is performed on the glass raw material 12 (Step is abbreviated as “S” in FIG. 5). In the cutting step, cutting processing is performed at positions (one light incoming end surface-side position and three non-light incoming end surface-side positions) shown by the broken lines in FIG. 6 respectively using a grinding apparatus. Incidentally, cutting processing does not have to be performed at the three non-light incoming end surface-side positions, but may be performed at the one light incoming end surface-side position and only one non-light incoming end surface-side position opposite thereto.

Due to the cutting processing, a glass substrate 14 is cut out from the glass raw material 12. Incidentally, the light guide plate 5 is made rectangular in planar view in the embodiment. Therefore, the cutting processing is performed at the one light incoming end surface-side position and the three non-light incoming end surface-side positions. However, the cutting positions may be selected suitably in accordance with the shape of the light guide plate 5.

When the cutting processing is terminated, a first chamfering step (Step 12) is performed. In the first chamfering step, the non-light incoming side chamfered surfaces 58 are formed both between the light outgoing surface 51 and the non-light incoming end surface 56 and between the light reflection surface 52 and the non-light incoming end surface 56 respectively by use of the grinding apparatus.

Incidentally, when the non-light incoming side chamfered surfaces 58 are formed between the light outgoing surface 51 and the non-light incoming end surface 54, between the light reflection surface 52 and the non-light incoming end surface 54, between the light outgoing surface 51 and the non-light incoming end surface 55 and between the light reflection surface 52 and the non-light incoming end surface 55 respectively, or when the non-light incoming side chamfered surface 58 is formed either between the light outgoing surface 51 and the non-light incoming end surface 54, between the light reflection surface 52 and the non-light incoming end surface 54, between the light outgoing surface 51 and the non-light incoming end surface 55 or between the light reflection surface 52 and the non-light incoming end surface 55, chamfering processing is performed in this first chamfering step.

In addition, chamfering may be performed between the light outgoing surface 51 and the light incoming end surface 53 or between the light reflection surface 52 and the light incoming end surface 53 in the first chamfering step. In this case, it is preferable in view of productivity that the surface roughness Ra in the obtained chamfered surface is higher than the surface roughness Ra of the light incoming side chamfered surfaces 57 obtained in a second chamfering step, which will be described later.

In addition, in the embodiment, grinding or polishing is performed on the non-light incoming end surfaces 54 to 56 in the first chamfering step. The grinding or polishing may be performed on the non-light incoming end surfaces 54 to 56 either before or after the aforementioned non-light incoming side chamfered surfaces 58 are formed, or may be performed at the same time. Incidentally, as for the non-light incoming end surfaces 54 and 55, surfaces subjected to the cutting processing may be used directly as the non-light incoming end surfaces 54 and 55.

Although the first chamfering step (Step 12) may be performed at the same time as or after a mirror-finishing step (Step 14) and a second chamfering step (Step 16), which will be described later, it is preferable that the first chamfering step is performed before those steps. As a result, processing in accordance with the shape of the light guide plate 5 can be performed at a comparatively high rate in Step 12. Thus, productivity can be improved while comparatively large cullet generated in Step 12 can be prevented from easily damaging the light incoming end surface 53 or the light incoming side chamfered surfaces 57.

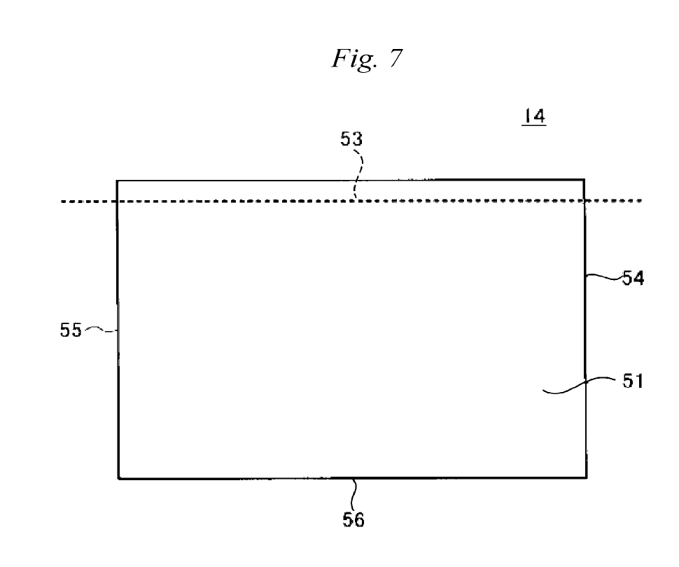

When the first chamfering step (Step 12) is terminated, the mirror-finishing step (Step 14) is next performed. In the mirror-finishing step, the light incoming end surface 53 is formed by mirror-finishing on the light incoming end surface side of the glass substrate 14 as shown in FIG. 7. As described above, the light incoming end surface 53 is a surface on which light is incident from the light source 4. Thus, the light incoming end surface 53 is mirror-finished to have a surface roughness Ra not higher than 0.03 μm.

When the light incoming end surface 53 is formed in the glass substrate 14 in the mirror-finishing step (Step 14), the second chamfering step (Step 16) is successively performed. Thus, the light incoming side chamfered surfaces 57 (chamfered surfaces) are formed by grinding or polishing between the light outgoing surface 51 and the light incoming end surface 53 and between the light reflection surface 52 and the light incoming end surface 53. Incidentally, Step 16 may be performed before Step 14, or may be performed at the same time as Step 14.

In the second chamfering step, when the average value of the width X of each light incoming side chamfered surface 57 in the longitudinal direction is denoted as Xₐᵥₑ, processing is performed so that the error of X in the longitudinal direction can be put preferably within 50% of Xₐᵥₑ, and the surface roughness Ra can be made preferably not higher than 0.4 μm.

When the light incoming side chamfered surfaces 57 are formed, a grindstone may be used as a tool for grinding or polishing. In addition to the grindstone, a buff, a brush or the like made of cloth, leather, rubber or the like may be used. In addition, on that occasion, abrasives such as cerium oxide, alumina, carborundum, colloidal silica, etc. may be used.

The aforementioned respective steps shown by Steps 10 to 16 are performed to manufacture the light guide plate 5. Incidentally, the aforementioned reflection dots 10A to 10C are printed on the light reflection surface 52 after the light guide plate 5 is manufactured.

Although the preferred embodiment of the present invention has been described in detail, the present invention is not limited to the aforementioned specific embodiment, but various modifications or changes can be made on the present invention within the gist of the present invention.

### EXAMPLES

The present invention will be described specifically along its examples. However, the present invention is not limited by the examples.

In the following Experiments 1 to 3, a glass plate (measuring 50 mm in length, 50 mm in width and 2.5 mm in thickness) containing SiO₂ of 71.6%, Al₂O₃ of 0.97%, MgO of 3.6%, CaO of 9.3%, Na₂O of 13.9%, K₂O of 0.05%, and Fe₂O₃ of 0.005% in terms of mass % on the basis of oxides was used as each glass plate. The glass plate had been cut out in the cutting step from a glass sheet manufactured by a float process (corner portions of the glass were cut off to prevent cracking when cutting was performed). The glass had four end surfaces between a light outgoing surface and a light reflection surface. Of the four end surfaces, one end surface was a light incoming end surface, and the three end surfaces were non-light incoming end surfaces.

After the cutting processing, the first chamfering step was performed. In the first chamfering step, grinding was performed on the three non-light incoming end surfaces. Further, chamfering was performed on the glass between the light outgoing surface and each non-light incoming end surface, and between the light reflection surface and each non-light incoming end surface, between the light outgoing surface and the light incoming end surface or between the light reflection surface and the light incoming end surface, by use of a grinding apparatus.

### Experiment 1

First, an experiment for investigating a relation between Ra of the non-light incoming end surfaces and transmittance of light was performed.

Table 1 shows the surface roughness Ra of the non-light incoming end surfaces in each of samples according to Examples 1 to 6.

TABLE 1

| | Ex. 1 | Ex. 2 | Ex. 3 | Ex. 4 | Ex. 5 | Ex. 6 |
|---|---|---|---|---|---|---|
| Ra (μm) | 0.010 | 0.012 | 0.029 | 0.037 | 0.070 | 0.110 |
| Transmittanc [symbol] | 0.0185 | −0.0296 | 0.0462 | −0.0585 | −1.9109 | −4.3508 |
| difference (%) | | | | | | |

[symbol]

indicates data missing or illegible when filed

After the first chamfering step, a mirror-finishing step was performed. In the mirror-finishing step, mirror-finishing was performed on the light incoming end surface. The surface roughness Ra of the light incoming end surface in each of the samples obtained according to Examples 1 to 6 was 0.01 μm. Following the mirror-finishing step, a second chamfering step was performed to perform grinding between the light outgoing surface and the light incoming end surface and between the light reflection surface and the light incoming end surface to thereby form light incoming side chamfered surfaces.

Transmittance of a non-light incoming end surface was measured in each of the samples according to Examples 1 to 6. In the measurement, lights with wavelengths of 400 nm to 800 nm were made incident on each sample from the light incoming end surface side toward the non-light incoming end surface opposite to the light incoming end surface to measure transmittances, and an average transmittance was calculated from measured values of the transmittances. In addition to the samples according to Examples 1 to 6, similar measurement was performed on a reference sample whose non-light incoming end surfaces had been optically polished, and an average transmittance in the wavelengths of 400 nm to 800 nm was calculated. Table 1 also shows a value of a difference between the average transmittance of each of the samples according to Examples 1 to 6 in the wavelengths of 400 nm to 800 nm and the average transmittance of the reference sample in the wavelengths of 400 nm to 800 nm. (hereinafter also simply referred to as transmittance difference).

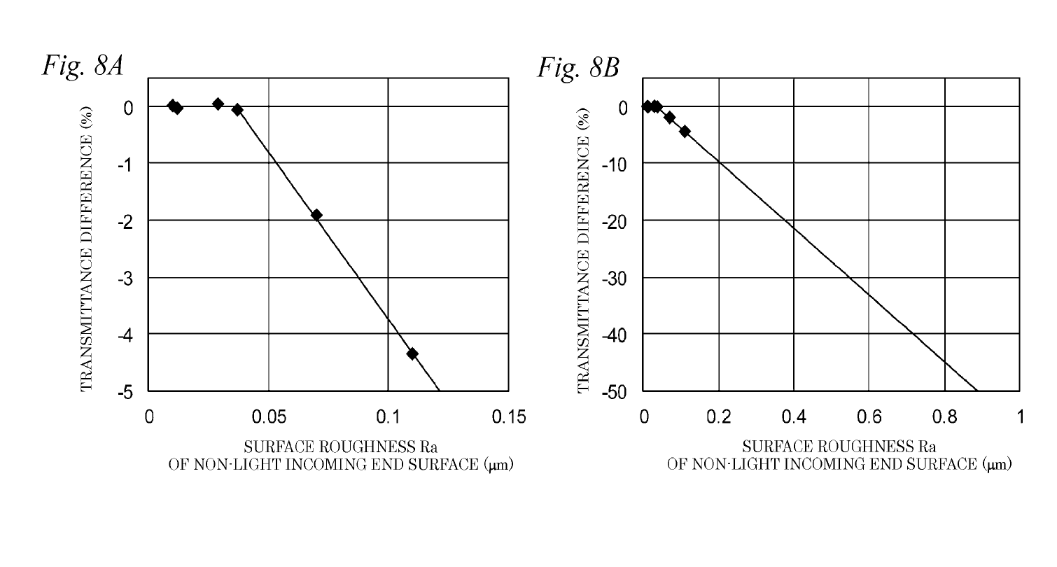

In addition, each of FIG. 8A and FIG. 8B shows a relation between the surface roughness Ra and the transmittance difference in each of the samples according to Examples 1 to 6. In each of FIG. 8A and FIG. 8B, the surface roughness Ra and the transmittance difference shown in Table 1 are plotted. Only the range showing an approximate curve is changed between FIG. 8A and FIG. 8B.

As shown in FIG. 8A and FIG. 8B, the transmittance difference can no longer be ignored when the surface roughness Ra of the non-light incoming end surfaces exceeds 0.04 μm. When the surface roughness Ra of the non-light incoming end surfaces exceeds 0.8 μm, the transmittance difference is below −50%. Thus, most of incident light that has not been transmitted through the non-light incoming end surfaces is diffused and reflected (irregularly reflected) by the non-light incoming end surfaces, causing reduction in luminance.

### Experiment 2

Next, an experiment for investigating a relation between an adhering area and adhesion between a non-light incoming end surface and a reflection sheet was performed. First, reflection sheets (product name: light-shading polyester film adhesive tape, product number: No. 6370, manufactured by Teraoka Seisakusho Co., Ltd.) whose tape widths were 6 mm, 12 mm and 24 mm respectively were prepared, and disposed on surfaces of glasses which were 0.0044 μm in surface roughness Ra. For each of samples obtained thus, 180° peel adhesion testing was performed on an adhesive tape/adhesive sheet according to JIS Z 0237. A table-top type precision universal tester (model name: AGS-5kNX, manufactured by Shimadzu Corporation) was used as a tester. The peel adhesion testing was performed 5 times for each sample, and an average value of adhesion P (N/10 mm) (hereinafter also simply referred to as adhesion) was calculated from a value of a product F(N) of the measured adhesion and the tape width. Adhesions obtained thus are shown in Table 2.

TABLE 2

| | | | |
|---|---|---|---|
| Tape width (mm) | 6.0 | 12.0 | 24.0 |
| Product F(N) of adhesion and tape width | 5.49 | 10.83 | 20.06 |
| Adhesion P (N/10 mm) | 9.15 | 9.03 | 8.36 |

Since the area of each reflection sheet is proportional to its tape width, it is understood that the product F of the adhesion and the tape width is approximately proportional to the area of the reflection sheet. In addition, when reflection sheets are provided on glass surfaces having the same surface roughness Ra, it can be considered that the area void ratio in the interface between each non-light incoming end surface and one of the reflection sheets is identical to the area void ratio in the interface between each non-light incoming end surface and the other reflection sheet. Accordingly, it is understood that the area (adhering area) in which each non-light incoming end surface and a reflection sheet are actually adhered to each other is approximately proportional to the aforementioned F thereof. Thus, when peel adhesion testing is performed on samples having a plurality of values of surface roughness Ra using reflection sheets made of the same material and having the same area, an adhering area or an area void ratio can be calculated relatively.

As the area void ratio is higher, the ratio of the adhering area in an interface between a non-light incoming end surface and a reflection sheet becomes smaller. As a result, incident light transmitted by the non-light incoming end surface in Experiment 1 cannot arrive directly at the reflection sheet in the interface, but the light can be diffused and reflected easily by voids.

### Experiment 3

Successively, an experiment for investigating influence of the surface roughness Ra of a non-light incoming end surface on adhesion between the non-light incoming end surface and a reflection sheet was performed. First, reflection sheets (product name: light-shading polyester film adhesive tape, product number: No. 6370, manufactured by Teraoka Seisakusho Co., Ltd.) whose tape widths were 12 mm were prepared, and disposed on surfaces of glasses which were 0.0044 μm, 0.0395 μm, 0.0677 μm, 0.1170 μm, 0.1640 μm, 0.4040 μm, 0.5670 μm, and 2.686 μm in surface roughness Ra respectively. These samples thus obtained were Examples 7 to 14 respectively. In the same manner, reflection sheets whose tape widths were 24 mm were disposed on surfaces of glasses which were 0.0044 μm, 0.0395 μm, 0.0677 μm, 0.117 μm, 0.164 μm, 0.404 μm, 0.567 μm, and 2.686 μm in surface roughness Ra respectively. These samples thus obtained were Examples 15 to 22 respectively.

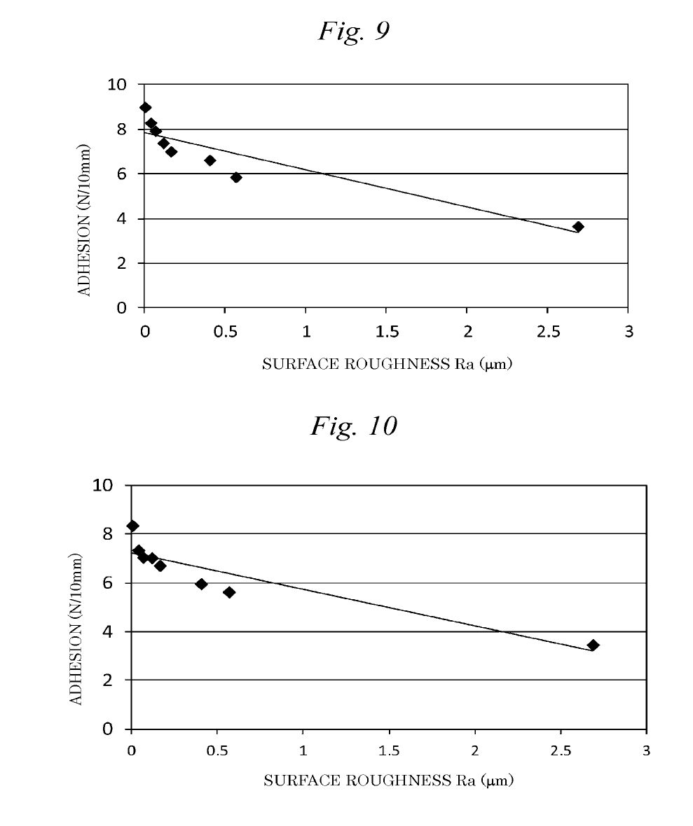

For each of the samples, peel adhesion testing was performed on an adhesive tape/adhesive sheet according to JIS Z 0237 in the same manner as in Experiment 2. The peel adhesion testing was performed 5 times for each sample, and an average value of adhesion P (N/10 mm) (hereinafter also simply referred to as adhesion) was calculated. Table 3 shows the adhesion P in the interface between the non-light incoming end surface and the reflection sheet in each sample according to Examples 7 to 22. Table 3 also shows an area void ratio calculated from the adhesion P when the area void ratios in Example 7 and Example 15 are regarded as 0%. In addition, FIG. 9 shows a relation between the surface roughness Ra and the adhesion P in each sample according to Examples 7 to 14, and FIG. 10 shows a relation between the surface roughness Ra and the adhesion P in each sample according to Examples 15 to 22.

TABLE 3

| | Ex. 7 | Ex. 8 | Ex. 9 | Ex. 10 | Ex. 11 | Ex. 12 | Ex. 13 | Ex. 14 |
|---|---|---|---|---|---|---|---|---|
| Ra (μm) | 0.0044 | 0.0395 | 0.0677 | 0.117 | 0.164 | 0.404 | 0.567 | 2.686 |
| Adhesion P | 9.03 | 8.32 | 7.96 | 7.41 | 7.03 | 6.65 | 5.89 | 3.68 |
| (N/10 mm) | | | | | | | | |
| Ar [symbol] a void | 0 | 7.8 | 11.8 | 17.9 | 22.1 | 26.4 | 34.8 | 59.2 |
| ratio (%) | | | | | | | | |
| | Ex. 15 | Ex. 16 | Ex. 17 | Ex. 18 | Ex. 19 | Ex. 20 | Ex. 21 | Ex. 22 |
| Ra (μm) | 0.0044 | 0.0395 | 0.0677 | 0.117 | 0.164 | 0.404 | 0.567 | 2.686 |
| Adhesion P | 8.36 | 7.35 | 7.05 | 7.03 | 6.72 | 5.97 | 5.63 | 3.47 |
| (N/10 mm) | | | | | | | | |
| Area void | 0 | 12.1 | 15.6 | 15.9 | 19.7 | 28.6 | 32.6 | 58.5 |
| ratio (%) | | | | | | | | |

[symbol]

indicates data missing or illegible when filed

From above, it is understood that there is a positive correlation between the surface roughness Ra of the non-light incoming end surface and the area void ratio. Thus, it has been proved that when the surface roughness Ra of the non-light incoming end surface exceeds 0.8 the area void ratio exceeds 40%, so that reduction in luminance cannot be ignored.

Although the invention has been described in detail along its specific embodiment, it is obvious for those in the art that various changes and modifications can be made on the invention without departing from the spirit and scope of the invention.

Incidentally, the present application is based on a Japanese patent application (Japanese Patent Application No. 2015-025339) filed on Feb. 12, 2015, the whole contents of which are incorporated herein by reference.

### DESCRIPTION OF REFERENCE NUMERALS AND SIGNS

1 liquid crystal display device

2 liquid crystal panel

3 planar light emitting unit

4 light source

5 light guide plate (glass)

6 reflection sheet

7 diffusing sheet

8 reflector

10A-10C reflection dot

12 glass raw material

14 glass substrate

51 light outgoing surface (first surface)

52 light reflection surface (second surface)

53 light incoming end surface (first end surface)

54,55,56 non-light incoming end surface (second end surface)

57 light incoming side chamfered surface (first chamfered surface)

58 non-light incoming side chamfered surface (second chamfered surface)

1. A glass member comprising a glass and a reflection sheet, wherein the glass comprises:
a first surface;
a second surface opposite to the first surface;
at least one first end surface that is provided between the first surface and the second surface; and
at least one second end surface that is provided between the first surface and the second surface and is different from the first end surface,
the glass has an effective optical path length of 5 cm to 200 cm,
the glass has an average internal transmittance of at least 80% in a visible light region over the effective optical path length,
the second end surface has a surface roughness Ra of not higher than 0.8 μm, and
the reflection sheet is disposed on the second end surface.

2. The glass member according to claim 1, wherein the first surface has a rectangular shape,
the glass has at least three of the second end surfaces, and
each of the second end surfaces has the surface roughness Ra of not higher than 0. 8 μm.

3. The glass member according to claim 1, wherein the surface roughness Ra of the second end surface is not lower than a surface roughness Ra of the first end surface.

4. The glass member according to claim 3, wherein the surface roughness Ra of the second end surface is higher than the surface roughness Ra of the first end surface.

5. The glass member according to claim 1,
wherein the glass has at least one chamfered surface between the first surface or the second surface and the second end surface, and
Lₘₐₓ≦1.5×Lₐᵥₑ and Lₘᵢₙ≧0.5×Lₐᵥₑ are satisfied when an average value of a width L of the second end surface in a longitudinal direction is denoted as Lₐᵥₑ (mm), and a maximum value and a minimum value of the width L are denoted as Lₘₐₓ (mm) and Lₘᵢₙ (mm) respectively.

6. The glass member according to claim 1, wherein an area void ratio V obtained by the following expression in an interface between the second end surface and the reflection sheet is not higher than 40%:
V=100×(1−P/P₀),
in which,
P: peel adhesion (N/10 mm) of the reflection sheet to the second end surface, the peel adhesion being measured by peel adhesion testing according to J1S Z 0237, and
P₀: peel adhesion (N/10 mm) of the reflection sheet to an end surface of the glass whose surface roughness Ra is not higher than 0.0050 μm, the peel adhesion being measured by peel adhesion testing according to JIS Z 0237.

7. The glass member according to claim 1, wherein the reflection sheet includes at least one selected from the group consisting of polyester resin, acrylic resin and urethane resin.

8. A glass member comprising a glass, wherein the glass comprises:
a first surface;
a second surface opposite to the first surface;
at least one first end surface that is provided between the first surface and the second surface; and
at least one second end surface that is provided between the first surface and the second surface and is different from the first end surface,
the glass has an effective optical path length of 5 cm to 200 cm,
the glass has an average internal transmittance of at least 80% in a visible light region over the effective optical path length, and
the second end surface has a surface roughness Ra of not higher than 0.8 μm.

9. The glass member according to claim 8, wherein the first surface has a rectangular shape,
the glass has at least three of the second end surfaces, and
each of the second end surfaces has the surface roughness Ra of not higher than 0. 8 μm.

10. The glass member according to claim 8, wherein the surface roughness Ra of the second end surface is not lower than a surface roughness Ra of the first end surface.

11. The glass member according to claim 10, wherein the surface roughness Ra of the second end surface is higher than the surface roughness Ra of the first end surface.

12. The glass member according to claim 8,
wherein the glass has at least one chamfered surface between the first surface or the second surface and the second end surface, and
Lₘₐₓ≦1.5×Lₐᵥₑ and Lₘᵢₙ≧0.5×Lₐᵥₑ are satisfied when an average value of a width L of the second end surface in a longitudinal direction is denoted as Lₐᵥₑ (mm), and a maximum value and a minimum value of the width L are denoted as Lₘₐₓ (mm) and Lₘᵢₙ (mm) respectively.
